(19) United States
(12) Patent Application Publication
(10) Pub. No.: US 2023/0160445 A1
(43) Pub. Date: May 25, 2023

(54) GUIDE ELEMENT AND BRAKE ANCHOR FOR A DISK BRAKE SYSTEM, AND DISK BRAKE SYSTEM

(71) Applicant: ZF Active Safety GmbH, Koblenz (DE)

(72) Inventors: Guido Zenzen, Macken (DE); Marco Becker, Oberduerenbach (DE); Peter Maeurer, Koblenz (DE); Lukas Madzgalla, Lahnstein (DE); Jörg Knieper, Vallendar (DE); Florian Roessinger, Neuwied (DE); Philipp Schwenzer, Urmitz (DE)

(21) Appl. No.: 17/992,973

(22) Filed: Nov. 23, 2022

(30) Foreign Application Priority Data
Nov. 23, 2021 (DE) 102021213156.5

(51) Int. Cl. F16D 65/00; F16D 55/226; F16D 65/095

(52) U.S. Cl. CPC F16D 65/0087; F16D 55/2262; F16D 65/0056; F16D 65/095; F16D 2055/0008

(57) ABSTRACT

The disclosure illustrates and describes a guide element which extends from a first end via a guide portion to a second end. The guide element has a fixing portion arranged at the second end and extending along a first extent direction, which runs transversely with respect to the axial direction, to a free end. The guide element has a connecting portion between the guide portion and the fixing portion. The connecting portion extends along a second extent direction, which runs transversely with respect to the axial direction and transversely with respect to the second extent direction, and extends along the axial direction from a first plane, which runs perpendicular to the axial direction, to a second plane, which runs perpendicular to the axial direction. The fixing portion is spaced apart in an axial direction both from the first plane and from the second plane. The disclosure furthermore relates to a corresponding brake anchor and to a corresponding disk brake system.

### CROSS-REFERENCE TO RELATED APPLICATION

This application claims priority to German Priority Application No. 10202121356.5, filed Nov. 23, 2021, the disclosure of which is incorporated herein by reference in its entirety.

### TECHNICAL FIELD

The present disclosure relates to a guide element for a disk brake system, to a brake anchor for a disk brake system, and to a disk brake system.

### BACKGROUND

Guide elements for a disk brake system are known from the prior art. Normally, such a disk brake system has a brake anchor and a brake pad arrangement. The brake pad arrangement has a brake pad that can be brought into contact with a brake disk. A rotational movement of the brake disk about an axis of rotation can be braked by way of this contact. In order to bring the brake pad into contact with the brake disk, the brake pad arrangement can be adjusted along an axial direction relative to the brake anchor. For this purpose, the brake anchor normally has a guide groove that extends along the axial direction. The brake pad arrangement normally has a guide projection for this relative movement. If contact has been established between the brake pad and the brake disk as a result of a relative movement of the brake pad arrangement relative to the brake anchor, a corresponding braking force acts on the brake pad arrangement.

In order to transmit this braking force to the brake anchor and, via the latter, to a frame of a vehicle, the brake anchor has a first abutment surface and the brake pad arrangement has a second abutment surface. Via the first abutment surface and the second abutment surface, the braking force can be transmitted from the brake pad arrangement to the brake anchor by virtue of the first abutment surface and the second abutment surface bearing against one another during a braking operation.

Guide elements are provided in order to optimize the relative movement between the brake pad arrangement and the brake anchor, which guide elements may be arranged between the brake anchor and the brake pad arrangement, for example, between the guide groove and the guide projection. In general, it is desirable that, if such guide elements are used, these are of space-saving, material-saving and weight-saving configuration and can be easily attached to a brake anchor.

### SUMMARY

What is needed is a guide element which is of space-saving, material-saving and weight-saving configuration and which can be easily attached to a brake anchor, and to provide a brake anchor which is adapted to such a guide element.

According to a first aspect of the disclosure, a guide element is provided for a disk brake system. The disk brake system has a brake anchor and a brake pad arrangement. The brake anchor has a guide groove that extends along an axial direction. The brake pad arrangement has a guide projection. The brake pad arrangement is adjustable relative to the brake anchor along the axial direction. The guide projection protrudes into the guide groove. The guide element extends from a first end via a guide portion to a second end. The guide element has a fixing portion, said fixing portion being arranged at the second end and extending along a first extent direction, which runs transversely with respect to the axial direction, to a free end. Furthermore, the guide element has a connecting portion between the guide portion and the fixing portion, said connecting portion extending along a second extent direction which runs transversely with respect to the axial direction and transversely with respect to the second extent direction. The connecting portion extends along the axial direction from a first plane, which runs perpendicular to the axial direction, to a second plane, which runs perpendicular to the axial direction. The fixing portion is spaced apart in an axial direction both from the first plane and from the second plane.

The guide element is provided for a disk brake system. The first aspect of the disclosure relates to the guide element. The guide element can be correspondingly adapted in a manner dependent on the disk brake system for which the guide element is provided. Where references are made to the disk brake system in the context of the guide element, these references serve for the purpose of clearly defining the different elements of the guide element, for example in order to illustrate the advantages of the different elements of the guide element in relation to the prior art. For example, the guide element according to the first aspect is advantageous in relation to the prior art in that the connecting portion extends along the axial direction from the first plane to the second plane and the fixing portion is spaced apart in the axial direction both from the first plane and from the second plane.

The disk brake system has the brake anchor and the brake pad arrangement. The brake pad arrangement may have a brake pad that can be brought into contact with a brake disk. A rotational movement of the brake disk about an axis of rotation can be braked by way of this contact. In one exemplary arrangement, the brake anchor may be fastened to a frame of the vehicle such that, when the brake pad is in contact with the brake disk, a braking force can be transmitted from the brake pad arrangement to the brake anchor and from the brake anchor to the frame of the vehicle.

The brake anchor has the guide groove that extends along the axial direction. In the context of the present disclosure, the axial direction relates to an assembled state in which the brake anchor, the brake pad arrangement and the brake disk of the disk brake system have been assembled. Specifically, in this assembled state, the axial direction extends parallel to the axis of rotation of the brake disk. The guide groove extends along the axial direction such that the guide groove restricts the movement of the guide projection during the adjustment of the brake pad arrangement relative to the brake anchor along the axial direction, in such a way that the brake pad of the brake pad arrangement can make contact with the brake disk along the axial direction. For example, the brake pad arrangement is guided only indirectly by the brake anchor, because the guide element, and in one exemplary arrangement, the guide portion of the guide element, is arranged between the brake pad arrangement and the brake anchor. In one exemplary arrangement, the guide portion of the guide element is in a region of the guide groove and in the region of the guide projection.

The brake pad arrangement has the guide projection. The guide projection extends along the axial direction, such that an extent of the guide projection along the axial direction is smaller than an extent of the guide groove in the axial direction. The guide projection extends along the first extent direction from the rest of the brake pad arrangement to a free end. In one exemplary arrangement, the guide projection has, at its free end, a surface that extends along a plane that is arranged perpendicular to the first extent direction. Furthermore, the guide projection has, between its free end and the rest of the brake pad arrangement, two surfaces which extend in each case along a corresponding plane which is arranged perpendicular to the plane described immediately above. The two planes along which the two surfaces extend are spaced apart from one another along a second extent direction, which is arranged transversely with respect to the axial direction and transversely with respect to the first extent direction. The three surfaces of the guide projection that are described here may be, at least in certain portions, arranged in the guide portion of the guide element.

The brake pad arrangement is adjustable relative to the brake anchor along the axial direction. The brake pad arrangement can thus be moved along the axial direction to an assembled brake disk and moved away from said brake disk in order to initiate a braking operation or end a braking operation.

The guide projection protrudes into the guide groove. By virtue of the fact that the guide projection protrudes into the guide groove, precise guidance of the brake pad arrangement is ensured. As already described, the brake pad arrangement is guided only indirectly by the brake anchor, because the guide element, in particular the guide portion of the guide element, may be arranged between the brake pad arrangement and the brake anchor, in particular in the region of the guide groove and in the region of the guide projection.

The guide element extends from the first end via the guide portion to the second end. For example, provision is made whereby the guide element does not extend entirely along a plane. The guide element may rather extend in certain portions along one or more planes. In one exemplary arrangement, provision is made whereby the guide element, at the first end, extends in certain portions along a plane, in the region of the guide portion, extends on one side of a further plane which is arranged perpendicular to the plane, for example extends in certain portions perpendicularly away from the further plane and in certain portions parallel to the further plane, and at the second end, extends at least transversely with respect to the further plane. For example, the guide element may, at the second end, extend perpendicular to the further plane or at an angle with respect to the further plane. In one exemplary arrangement, provision is made whereby the guide element is U-shaped in the region of the guide portion.

In one exemplary arrangement, the guide portion has a first end portion and a second end portion. The guide portion extends from the first end portion to the second end portion. In one exemplary arrangement, the guide portion is U-shaped between the first end portion and the second end portion and defines a first side of the guide element, on which the U-shape is closed, and a second side, situated opposite the first side, of the guide element, on which the U-shape is open. The guide portion may have a first portion comprising the first end portion, a second portion, and a third portion comprising the second end portion. The second portion of the guide portion extends along the second extent direction. The second portion is arranged between the first portion and the third portion along the second extent direction. The second portion has a first surface on the first side of the guide element and has a second surface on the second side of the guide element. The first surface of the second portion and the second surface of the second portion extend in each case along a corresponding plane that is arranged perpendicular to the first extent direction. The first surface and the second surface face away from one another.

In one exemplary arrangement, the second portion of the guide portion and the arrangement of the first portion of the guide portion and of the third portion of the guide portion relative to the second portion define both the first side of the guide element and the second side of the guide element. The first portion, the second portion and the third portion together form a U-shape, wherein the first side is arranged on the closed side of the U-shape and the second side is arranged on the open side of the U-shape. The first portion and the third portion extend away from the second portion on the second side. The first portion and the third portion extend along the first extent direction. Both the first portion and the third portion extend in each case perpendicularly away from the second portion. The first portion has a first surface on the first side and has a second surface on the second side. The first surface and the second surface of the first portion extend in each case along a corresponding plane that is arranged perpendicular to the second extent direction. The first surface and the second surface face away from one another. The third portion has a first surface on the first side and has a second surface on the second side. The first surface and the second surface of the third portion extend in each case along a corresponding plane that is arranged perpendicular to the second extent direction. The first surface and the second surface face away from one another.

In one exemplary arrangement, the guide portion engages, on the first side of the guide element, into the guide groove, and the guide projection engages, on the second side, into the guide portion. The guide portion is configured such that the guide element is adapted both to the shape of the guide groove and to the shape of the guide projection. The engagement of the guide portion into the guide groove and the engagement of the guide projection into the guide portion is such that both the guide projection and the second surface of the first portion of the guide portion and the guide projection and the second surface of the second portion of the guide portion are in each case spaced apart from one another. The guide portion ensures a reliable adjustment of the brake pad arrangement in an axial direction relative to the brake anchor in that, forces acting along the second extent direction can be transmitted from the guide projection to the third portion of the guide portion and from the third portion of the guide portion to the brake anchor. For example, here, the first surface of the third portion of the guide portion can bear against a surface of the brake anchor which extends along a plane oriented perpendicular to the second extent direction and which forms a portion of a surface of the guide groove.

The guide element has the fixing portion, said fixing portion being arranged at the second end and extending along the first extent direction, which runs transversely with respect to the axial direction, to the free end. The first extent direction runs transversely with respect to the axial direction. For example, the axial direction and the first extent direction run perpendicular to one another. The fixing portion extends from one end portion along the first extent direction to the free end. The fixing portion extends, at least in certain portions, perpendicular to the connecting portion.

In one exemplary arrangement, the fixing portion may be provided as a single arm which extends as a single piece from its end portion to its free end, which provides a space-saving, material-saving and weight-saving alternative in relation to guide elements in the case of which two individual arms are provided, which each extend as a single piece from a corresponding end portion to a corresponding free end. In one exemplary arrangement, the fixing portion extends such that a main extent plane of the fixing portion is provided perpendicular to the second extent direction, wherein the fixing portion extends along said main extent plane. In one exemplary arrangement, an extent of the fixing portion perpendicular to said main extent plane is smaller than an extent of the fixing portion along said main extent plane, such that, forces that act perpendicular to said main extent plane can be introduced into the fixing portion in an effective manner. As already described, the fixing portion can have a curved shape. If the fixing portion has a curved shape, the fixing portion does not extend entirely along the main extent plane. Rather, in this case, the fixing portion extends, at least in certain portions, along the main extent plane and entirely between two planes running parallel to the main extent plane, which planes enclose the main extent plane between them, and the spacing of which planes to one another is smaller than an extent of the fixing portion along the axial direction and is smaller than an extent of the fixing portion along the first extent direction. In one exemplary arrangement, the fixing portion, at its free end, has no portion that extends along the second extent direction from a surface, pointing in the direction of the guide portion, of the fixing portion, such that the guide element can lie with its fixing portion against a portion of the brake anchor and the mounting of the guide element onto the brake anchor can be performed easily and quickly.

In one exemplary arrangement, the extent of the fixing portion along the first extent direction and to the free end can be understood to mean that two opposite surfaces of the fixing portion, which extend parallel to one another along the first extent direction, are provided so as to be continuous along the first extent direction from the end portion of the fixing portion to the free end of the fixing portion and in each case between two edges of the fixing portion which extend parallel to one another along the first extent direction. In one exemplary arrangement, the two mutually opposite surfaces are provided such that the spacing between the two surfaces is constant from the end portion to the free end. A constant spacing between the two surfaces ensures a particularly straightforward attachment of the guide element to the brake anchor.

Furthermore, the guide element has the connecting portion between the guide portion and the fixing portion, said connecting portion extending along the second extent direction which runs transversely with respect to the axial direction and transversely with respect to the second extent direction. The second extent direction runs transversely with respect to the axial direction and transversely with respect to the first extent direction. For example, the axial direction, the first extent direction and the second extent direction run perpendicular to one another. In particular, the connecting portion extends from a first end portion along the second extent direction to a second end portion. The second end portion of the guide portion and the first end portion of the connecting portion may transition directly into one another. The second end portion of the connecting portion and the end portion of the fixing portion may likewise transition directly into one another. By a direct transition of different elements of the guide element, a space-saving guide element can be provided.

The connecting portion may have in each case one corresponding surface on the first side of the guide element and on the second side of the guide element. The two surfaces of the connecting portion may extend in each case along a corresponding plane that is arranged perpendicular to the first extent direction, wherein the two surfaces of the connecting portion may face away from one another. In the assembled state, a first surface of the two surfaces of the connecting portion may face toward the brake anchor, and a second surface of the two surfaces of the connecting portion may face toward the brake pad arrangement. In particular, by the first surface, which faces toward the brake anchor, the connecting portion may bear against a surface of the brake anchor, such that the guide element is optimally positioned relative to the brake anchor when a braking operation of the disk brake system is performed. Furthermore, by the second surface, which faces toward the brake pad arrangement, the connecting portion may bear against a surface of the brake pad arrangement, such that the guide element is optimally positioned relative to the brake pad arrangement when a braking operation of the disk brake system is performed.

The connecting portion may have a first portion comprising the first end portion, a second portion comprising the second end portion, and a third portion. In particular, the third portion may have a portion of the first portion and/or a portion of the second portion. In particular, the first portion and the second portion serve for describing the extent of the connecting portion along the axial direction. The third portion serves in particular for describing the extent of the connecting portion along the second extent direction.

The connecting portion extends along the axial direction from the first plane, which runs perpendicular to the axial direction, to the second plane, which runs perpendicular to the axial direction. The connecting portion thus extends from the first plane to the second plane. This extent defines a maximum extent of the connecting portion along the axial direction. This maximum extent may for example be the extent of the first portion of the connecting portion and/or the extent of the second portion of the connecting portion, in each case along the axial direction.

The fixing portion is spaced apart in an axial direction both from the first plane and from the second plane. In one exemplary arrangement, the extent of the fixing portion along the axial direction is smaller than the extent of the connecting portion along the axial direction. For example, provision is made whereby the extent of the connecting portion along the axial direction corresponds to at least three times the extent of the fixing portion along the axial direction, which has led to surprisingly secure fastening of the guide element on the brake anchor. In relation to a guide element in a case of which the fixing portion extends in an axial direction as far as or further than a corresponding connecting portion, the guide element according to the disclosure provides a space-saving, material-saving and weight-saving alternative, because the fixing portion is spaced apart in an axial direction both from the first plane and from the second plane.

In summary, it can thus be stated that, by the arrangement and design of the fixing portion, a space-saving, material-saving and weight-saving guide element is ensured, and at the same time, the attachment of the guide element to the brake anchor is straightforward. For example, the fixing portion may bear, by two edges which are situated opposite one another along the axial direction and which extend along the first extent direction, against corresponding portions of the brake anchor such that precise positioning of the guide element relative to the brake anchor is ensured, and securing of the guide element against movement along the axial direction relative to the brake anchor is ensured. A guide element of space-saving, material-saving and weight-saving design is thus provided, which can be attached easily to a brake anchor.

In one exemplary arrangement, the fixing portion and the connecting portion transition directly into one another. By virtue of the fact that the fixing portion and the connecting portion transition directly into one another, a compact and material-saving guide element is provided.

In one exemplary arrangement, the fixing portion has an elastically deformable spring portion. The elastically deformable spring portion may also be referred to as second spring portion, wherein a spring portion of the guide element may also be referred to as first spring portion. The second spring portion can be brought from an unloaded state into an elastically prestressed state, in which the second spring portion is elastically deformed. In one exemplary arrangement, the second spring portion is not deformed in the unloaded state. In the elastically prestressed state, the second spring portion is deformed in linearly elastic fashion. A linearly elastic deformation of the second spring portion in the elastically prestressed state ensures that the second spring portion can be brought from the unloaded state into the elastically prestressed state and from the elastically prestressed state back into the unloaded state again, without residual plastic deformation of the second spring portion. In the unloaded state, the second spring portion can assume its original shape, without plastic deformation components influencing a future deformation behavior of the second spring portion. Furthermore, a linearly elastic deformation of the second spring portion in the elastically prestressed state can make it possible for a force that is exerted by the second spring portion in the elastically prestressed state to be maintained over a long period of use. The second spring portion is configured such that the second spring portion, in the elastically deformed state, can bear with an abutment surface against an abutment portion of the brake anchor such that a spring force acting along the second extent direction is exerted on the guide element. In one exemplary arrangement, the spring force may act on the guide element such that the guide element is forced, along the second extent direction, with the first surface of the third portion of the guide portion against a surface, which extends along a plane arranged perpendicular to the second extent direction, of the brake anchor, such that the guide element can be fastened securely to a portion of the brake anchor.

In one exemplary arrangement, the fixing portion has a curved shape such that the fixing portion deviates, at least in certain portions along the second extent direction, from a planar extent along a plane running perpendicular to the second extent direction. This curved shape can constitute a structurally particularly simple exemplary arrangement with which elastic deformability of the fixing portion can be ensured. It is also possible for other shapes to ensure elastic deformability of the fixing portion. The curved shape can likewise be utilized for ensuring a form-fitting connection between the fixing portion and the brake anchor. This form-fitting connection may be provided as an alternative or in addition to a force fit, provided by way of the elastically deformed second spring portion, between the guide element and the brake anchor.

In one exemplary arrangement, the guide portion has at least one projection which extends, along the second extent direction, away from a surface of the guide portion, which surface extends along a plane running perpendicular to the second extent direction. The at least one projection may have one projection or multiple projections, wherein, if multiple projections are provided, the projections are arranged spaced apart from one another, such that a corresponding portion of the surface is arranged in each case between two projections. In one exemplary arrangement, each projection extends along the second extent direction, and away from that surface of the guide portion which extends along the plane running perpendicular to the second extent direction, to a corresponding free end. The surface is the first surface of the third portion of the guide portion. By virtue of each projection being able to engage by way of its free end with a surface of the brake anchor, and the surface of the guide anchor not being able, or at least not only the surface of the guide anchor being able, to engage with the surface of the brake anchor, the generation of noise during the use of the guide element, for example during a braking operation, can be considerably reduced.

In one exemplary arrangement, the connecting portion has a first portion, which extends along the axial direction from the first plane to the second plane, and a second portion, which is spaced apart in the axial direction both from the first plane and from the second plane. In one exemplary arrangement, the extent of the first portion along the axial direction is smaller than a maximum extent of the connecting portion along the axial direction. The second portion is spaced apart in an axial direction both from the first plane and from the second plane. By virtue of the fact that the second portion is spaced apart in an axial direction both from the first plane and from the second plane, a connecting portion is provided which is space-saving, material-saving and weight-saving. Furthermore, the second portion may have two abutment elements which extend parallel to one another and along the second extent direction. The two abutment elements may be arranged, and spaced apart from one another in an axial direction, such that the fixing portion is arranged between the two abutment elements along the axial direction. This design of the two abutment elements ensures a large abutment area of the connecting portion for abutment against the brake anchor, and a large abutment surface of the connecting portion for abutment against the brake pad arrangement, in order to simultaneously provide a particularly space-saving, material-saving and weight-saving arrangement of the fixing portion.

In one exemplary arrangement, the connecting portion has a third portion which extends along the second extent direction from a third plane, which runs perpendicular to the second extent direction, to a fourth plane, which runs perpendicular to the second extent direction, wherein the third plane and the fourth plane are arranged such that the fixing portion is, at least in certain portions, arranged between the third plane and the fourth plane. The connecting portion thus extends along the second extent direction further than the fixing portion is arranged at least in certain portions. This ensures a large abutment area of the connecting portion for abutment against the brake anchor, and a large abutment surface of the connecting portion for abutment against the brake pad arrangement, and simultaneously ensures a space-saving, material-saving and weight-saving arrangement of the fixing portion. The third plane and the fourth plane may also be arranged such that the fixing portion is arranged entirely between the third plane and the fourth plane. The connecting portion thus extends along the second extent direction further than the fixing portion is arranged. This ensures a particularly large abutment area of the connecting portion for abutment against the brake anchor, and a large abutment surface of the connecting portion for abutment against the brake pad arrangement, and simultaneously ensures a particularly space-saving, material-saving and weight-saving arrangement of the fixing portion. If the fixing portion is arranged entirely between the third plane and the fourth plane, forces that are exerted on the connecting portion by the fixing portion can be transmitted to the brake anchor or to the brake pad arrangement in an efficient manner. This applies to forces that act along the first extent direction, or to forces that have at least one component that acts along the first extent direction. For example, a portion of the connecting portion may be arranged on one side of the fixing portion along the second extent direction, and a further portion of the connecting portion may be arranged on the other side of the fixing portion along the second extent direction.

According to a second aspect of the disclosure, a brake anchor is disclosed. The brake anchor has a guide groove that extends along an axial direction. The brake anchor is provided for a disk brake system. The disk brake system has a brake anchor and a brake pad arrangement which is adjustable relative to the brake anchor along the axial direction and which has a guide projection protruding into the guide groove. The brake anchor has a guide portion that has the guide groove. Furthermore, the brake anchor has a connecting portion which adjoins the guide portion and which extends along the axial direction from a fifth plane, which runs perpendicular to the axial direction, to a sixth plane, which runs perpendicular to the axial direction. The brake anchor furthermore has a holding portion that adjoins the connecting portion. The holding portion has a holding groove which extends along a first extent direction from a first end to a second end and which, at its second end, is open along the first extent direction and which is spaced apart in the axial direction both from the fifth plane and from the sixth plane. The features, technical effects and/or advantages described in conjunction with the guide element according to the first aspect of the disclosure also apply at least analogously to the brake anchor according to the second aspect of the disclosure, such that a corresponding repetition will be omitted here.

In the assembled state, in which the guide element is attached to the brake anchor, the axial direction, the first extent direction and the second extent direction are identical both for the guide element and for the brake anchor. In a state in which the guide element is not attached to the brake anchor, the axial direction, the first extent direction and the second extent direction may differ in each case for the guide element and the brake anchor. In one exemplary arrangement, the first plane corresponds to the fifth plane and the second plane corresponds to the sixth plane, such that an extent of the connecting portion of the guide element along the axial direction corresponds to an extent of the connecting portion of the brake anchor along the axial direction. The fixing portion of the guide element may engage into the holding groove. In one exemplary arrangement, in the assembled arrangement, the fixing portion of the guide element may be arranged entirely, or at least in certain portions, in the holding groove of the brake anchor. By virtue of the fact that the holding groove, at its second end, is open along the first extent direction, the guide element can be attached particularly easily by way of its fixing portion to the brake anchor. In an axial direction, the holding groove is spaced apart both from the fifth plane and from the sixth plane, such that the holding portion may have two limbs which extend along the first extent direction and which delimit the holding groove and prevent a movement of the fixing portion along the axial direction. In one exemplary arrangement, the guide portion has only one holding groove.

In one exemplary arrangement, the connecting portion has an abutment surface which points in the first extent direction and which extends along a seventh plane running perpendicular to the first extent direction, wherein the abutment surface and the second end of the holding groove transition directly into one another. The connecting portion of the guide element may bear against the abutment surface of the connecting portion of the brake anchor. Said abutment surface of the connecting portion of the brake anchor and the second end of the holding groove transition directly into one another, such that the guide element can be attached easily to the brake anchor.

In one exemplary arrangement, an extent of the holding groove in a direction from the fifth plane to the sixth plane increases along the second extent direction. The thus increasing extent of the holding groove ensures optimum positioning of the guide element on the brake anchor. For example, the extent of the holding groove in a direction from the fifth plane to the sixth plane may decrease toward a surface of the holding portion, which surface extends along a plane which is arranged perpendicular to the second extent direction and which delimits the holding groove in the direction of the second extent direction. In other words, the holding groove may taper along the second extent direction. An extent of the holding groove in a direction from the fifth plane to the sixth plane may be defined by an extent of the holding groove along a straight line that is defined by an intersection of two planes, of which one extends perpendicular to the first extent direction and one extends perpendicular to the second extent direction.

In one exemplary arrangement, a surface, pointing in the second extent direction, of the holding groove has a roughness that corresponds to or is greater than a minimum roughness, wherein the minimum roughness corresponds to an average roughness value of 0.8 micrometers. For example, an average roughness value of 0.8 micrometers may be achieved by virtue of at least the holding portion of the brake anchor being produced by casting. It has surprisingly been found that, if the minimum roughness corresponds to an average roughness value of 0.8 micrometers, the guide element can be attached reliably to the brake anchor and a movement of the guide element along the first extent direction during a braking operation can be avoided.

According to a third aspect of the disclosure, a disk brake system is disclosed. The disk brake system has a guide element according to the first aspect of the disclosure. The disk brake system has a brake anchor according to the second aspect of the disclosure. The disk brake system has a brake pad arrangement which is adjustable relative to the brake anchor along the axial direction and which has a guide projection protruding into the guide groove. The fixing portion of the guide element is, at least in certain portions, arranged in the holding groove of the brake anchor. The features, technical effects and/or advantages described in conjunction with the guide element according to the first aspect of the disclosure and the features, technical effects and/or advantages described in conjunction with the brake anchor according to the second aspect of the disclosure also apply at least analogously to the disk brake system according to the third aspect of the disclosure, such that a corresponding repetition will be omitted here.

In one exemplary arrangement, the fixing portion and the holding groove each extend, at least in certain portions, along the axial direction such that the fixing portion bears, at least in certain portions, against two mutually oppositely situated abutment surfaces that define the extent of the holding groove in the axial direction. With this design, stable securing of the guide element relative to the brake anchor along the axial direction is ensured. The fixing portion may bear with two mutually oppositely situated edges, which extend along the first extent direction, against the surfaces of the holding groove, wherein in each case one edge bears against one surface, and in this way the guide element is secured against movement along the axial direction relative to the brake anchor.

Further features, advantages and possible uses of the present disclosure will emerge from the following description of the exemplary arrangements and from the figures. Here, all features described and/or illustrated in the figures form the subject matter of the disclosure on their own and in any combination, even independently of their composition in the individual claims or the back-references thereof. Furthermore, in the figures, the same reference designations are used to denote the same or similar objects.

### BRIEF DESCRIPTION OF DRAWINGS

FIGS. 1 to 7 are schematic illustrations of a first exemplary arrangement of a guide element according to the disclosure. More specifically:

FIG. 1 is a perspective view of a brake anchor with a guide element;

FIG. 2 is an enlarged perspective view of the guide element;

FIG. 3 is an enlarged bottom perspective view of the guide element;

FIG. 4 is an elevational view of the guide element;

FIG. 5 is a top plan view of the guide element;

FIG. 6 is a cross-section view of the guide element taken along lines AA of FIG. 5;

FIG. 7 is a cross-sectional view of the guide element taken along lines B-B of FIG. 5; and

FIG. 8 is a schematic illustration of a second exemplary arrangement of the guide element according to the disclosure.

### DETAILED DESCRIPTION

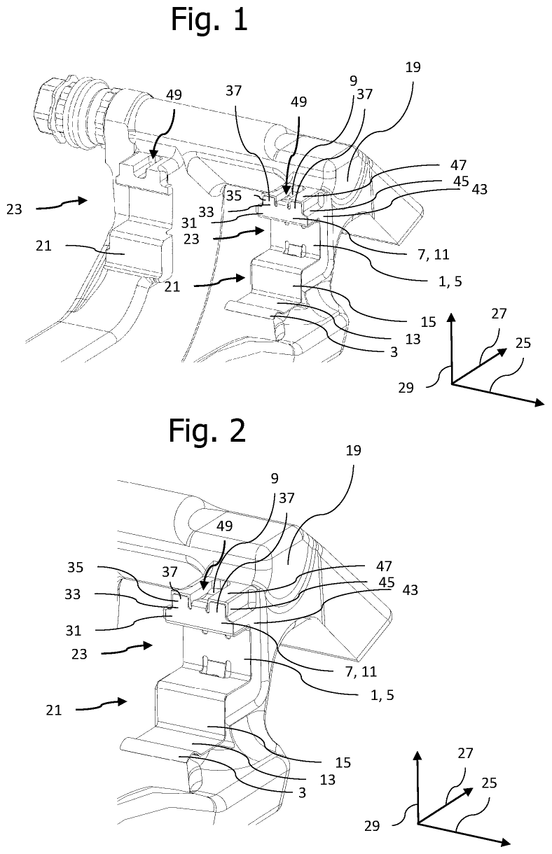

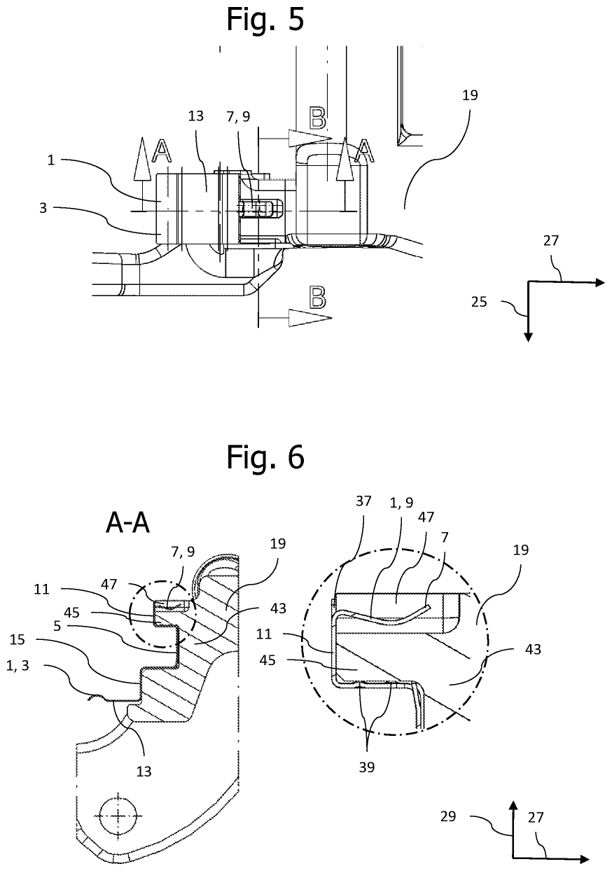

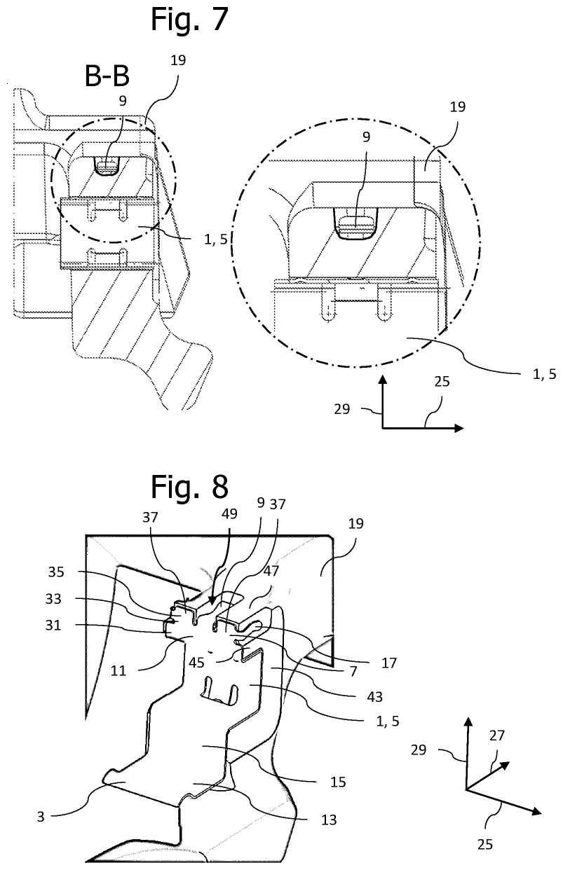

FIGS. 1 to 7 are schematic illustrations of a first exemplary arrangement of a guide element 1 according to the disclosure, and FIG. 8 is a schematic illustration of a second exemplary arrangement of the guide element 1 according to the disclosure.

The guide element 1 is formed as a single piece, such that the guide element 1 is mechanically robust, because connections between different portions of the guide element 1 can be omitted. For example, the guide element 1 may be punched out of a metal sheet and subsequently in plastically deformed and thus provided with its shape. The guide element 1 has a first end 3, a guide portion 5, and a second end 7. The guide element 1 extends from the first end 3 via the guide portion 5 to the second end 7. The guide portion 5 is U-shaped and defines a first side of the guide element 1, on which the U-shape is closed, and a second side, situated opposite the first side, of the guide element 1, on which the U-shape is open. At the second end 7, the guide element 1 has a fixing portion 9. Between the guide portion 5 and the fixing portion 9, the guide element 1 has a connecting portion 11. At the first end 3, the guide element 1 has an elastically deformable spring portion 13, and between the spring portion 13 and the guide portion 5, the guide element 1 has a planar portion 15.

The second exemplary arrangement, illustrated in FIG. 8, additionally has two fastening portions 17. The first exemplary arrangement does not have these fastening portions 17, whereby a particularly lightweight, material-saving and space-saving guide element 1 can be provided by the first exemplary arrangement.

The guide element 1 is designed for a disk brake system. The disk brake system has a brake anchor 19, of which a first portion is illustrated. The disk brake system furthermore has a brake pad arrangement, which is not illustrated in the figures. The portion of the brake anchor 19 that is illustrated in FIG. 1 has two first abutment surfaces 21, of which the first abutment surface 21 illustrated on the right in FIG. 1 is concealed by the guide element 1. Furthermore, the portion of the brake anchor 19 that is illustrated in FIG. 1 has two guide grooves 23, of which the guide groove 23 illustrated on the right in FIG. 1 is concealed by the guide element 1. The brake pad arrangement (not illustrated) has a second abutment surface and a guide projection. In an assembled arrangement illustrated in FIG. 1, the guide element 1 is arranged between the brake anchor 19 and the brake pad arrangement.

The brake pad arrangement is adjustable relative to the brake anchor 19 along an axial direction 25. By adjustment of the brake pad arrangement along the axial direction 25 relative to the brake anchor 19, the brake pad arrangement can be moved toward a brake disk of the disk brake system and away from the brake disk. The brake disk can be mounted so as to be rotatable about an axis of rotation arranged parallel to the axial direction 25, in such a way that said brake disk is arranged between the two first abutment surfaces 21 and between the two guide grooves 23 of that portion of the brake anchor 19 which is illustrated in FIG. 1, such that two brake pad arrangements can be provided, each of which is adjustable relative to the brake anchor 19 along the axial direction 25, such that the two brake pad arrangements can, from two mutually opposite sides of the brake disk, be moved toward the brake disk and away from the brake disk in order to respectively engage with the brake disk. Aside from the first portion illustrated in FIG. 1, the brake anchor 19 has a second portion, and the two brake pad arrangements each likewise have a second portion. The second portions are of mirror-symmetrical design with respect to the corresponding first portions, such that the first portion and the second portion of each brake pad arrangement are encompassed by the first portion and the second portion of the brake anchor 19, in such a way that, during the adjustment of the brake pad arrangements along the axial direction 25 relative to the brake anchor 19, the brake pad arrangements can be guided along the guide grooves 23 from two sides. The present disclosure relates substantially to the guide element 1 and to that portion of the brake anchor 19 with which the guide element 1 interacts.

In the first and second exemplary arrangement, in each case four guide elements 1, four portions of the brake anchor 19 and four portions of two brake pad arrangements (in each case two portions of each brake pad arrangement) are provided, with which a corresponding guide element 1 interacts. The features, technical effects and/or advantages described in conjunction with a or the guide element 1 also apply at least analogously to each of the four guide elements 1, the features, technical effects and/or advantages described in conjunction with a or the portion of the brake anchor 19 also apply at least analogously to each of the four portions of the brake anchor 19, and the features, technical effects and/or advantages described in conjunction with a or the portion of the brake pad arrangement also apply at least analogously to each of the four portions of the brake pad arrangement, such that a corresponding repetition will be omitted here.

The brake pad arrangement has a brake pad that faces toward the brake disk. By adjustment of the brake pad arrangement along the axial direction 25 relative to the brake anchor 19, the brake pad can be brought into contact with the brake disk, and said contact can be eliminated again. When the brake pad is in contact with the brake disk, a rotational movement of the brake disk about the axis of rotation that runs parallel to the axial direction 25 can be braked, which can also be referred to as a braking operation of the disk brake system. Thus, by adjustment of the brake pad arrangement along the axial direction 25 relative to the brake anchor 19, the rotational movement of the brake disk about the axis of rotation can be braked. The guide groove 23 extends along the axial direction 25, such that the guide projection that protrudes into the guide groove 23 can be guided along the guide groove 23, such that the brake pad arrangement can be moved toward and away from the brake disk in controlled fashion.

As already described, the guide groove 23 extends along the axial direction 25. When the brake anchor 19, the brake pad arrangement and a brake disk of the disk brake system have been assembled such that a braking operation of the disk brake system is effected as a result of the movement of the brake pad arrangement along the axial direction 25 relative to the brake anchor 19, the axial direction 25 and the axis of rotation of the brake disk run parallel to one another. In the context of the description of the guide element 1, the axial direction 25 relates to an assembled state in which the brake anchor 19, the brake pad arrangement and the brake disk of the disk brake system have been assembled. Specifically, in this assembled state, the axial direction 25 extends parallel to the axis of rotation of the brake disk.

An extent direction 27 of the fixing portion 9 runs transversely with respect to the axial direction 25. In the first and second exemplary arrangements, the axial direction 25 and the first extent direction 27 run perpendicular to one another. The planar portion 15 extends from a first end portion along a second extent direction 29 to a second end portion. The second extent direction 29 runs transversely with respect to the axial direction 25 and transversely with respect to the first extent direction 27. In the first and second exemplary arrangements, the second extent direction 29 runs perpendicular to the axial direction 25 and perpendicular to the first extent direction 27. The planar portion 15 is arranged between the first abutment surface 21 and the second abutment surface of the brake pad arrangement along the first extent direction 27.

During a braking operation of the disk brake system, a braking force is exerted by the first abutment surface 21 on the planar portion 15, and by the planar portion 15 on the second abutment surface, along the first extent direction 27. Both the first abutment surface 21 and the second abutment surface extend in each case along a corresponding plane that is arranged perpendicular to the first extent direction 27, wherein the first abutment surface 21 and the second abutment surface face toward one another. The planar portion 15 has in each case one corresponding abutment surface on the first side and on the second side. The two abutment surfaces of the planar portion 15 extend in each case along a corresponding plane that is arranged perpendicular to the first extent direction 27, wherein the two abutment surfaces of the planar portion 15 face away from one another. In an assembled state, and during a braking operation, one abutment surface of the two abutment surfaces of the planar portion 15 bears against the first abutment surface 21 of the brake anchor 19, and another abutment surface of the two abutment surfaces of the planar portion 15 bears against the second abutment surface of the brake pad arrangement. The planar portion 15 ensures that, when a braking operation of the disk brake system is performed and a braking force is exerted by the first abutment surface 21 on the planar portion 15, and by the planar portion 15 on the second abutment surface, along the first extent direction 27, a transmission of force between the brake anchor 19 and the brake pad arrangement can be ensured, and at the same time the mechanical loading of the guide element 1 can be kept low, in relation to an elastic and/or plastic deformation of the guide element 1, because the exertion of force on the guide element 1 is distributed over a large area owing to the planar nature of the planar portion 15. By virtue of the fact that the first abutment surface 21 of the brake anchor 19, the second abutment surface of the brake pad arrangement and the two abutment surfaces of the planar portion 15 extend in each case along a corresponding plane that is arranged perpendicular to the first extent direction 27, the transmission of force between the brake anchor 19 and the brake pad arrangement is optimized, such that the mechanical loading of the guide element 1 can be kept low, in relation to an elastic and/or plastic deformation of the guide element 1.

As has likewise already been described, the guide element 1 has the elastically deformable spring portion 13. The spring portion 13 extends along the first extent direction 27 from an end portion to a free end. The end portion of the spring portion 13 and the first end portion of the planar portion 15 transition directly into one another. In one exemplary arrangement, the spring portion 13 extends, at least in certain portions, perpendicular to the planar portion 15. The spring portion 13 can be brought from an unloaded state into an elastically prestressed state, in which the spring portion 13 is elastically deformed. The spring portion 13 is not deformed in the unloaded state. In the elastically prestressed state, the spring portion 13 is deformed in linearly elastic fashion. A linearly elastic deformation of the spring portion 13 in the elastically prestressed state ensures that the spring portion 13 can be brought from the unloaded state into the elastically prestressed state and from the elastically prestressed state back into the unloaded state again, without residual plastic deformation of the spring portion 13. In the unloaded state, the spring portion 13 can assume its original shape, without plastic deformation components influencing a future deformation behavior of the spring portion 13. Furthermore, a linearly elastic deformation of the spring portion 13 in the elastically prestressed state can make it possible for a force that is exerted by the spring portion 13 in the elastically prestressed state to be maintained over a long period of use. The spring portion 13 is configured such that the spring portion 13 bears, under elastic deformation, with an abutment surface against an abutment portion of the brake pad arrangement in such a way that a spring force acting transversely with respect to the axial direction 25 and transversely with respect to the first extent direction 27 acts on the guide element 1. In one exemplary arrangement, the spring force also acts on the brake pad arrangement such that the latter bears with an abutment surface, which extends along a plane arranged perpendicular to the second extent direction 29, of the guide projection against a surface, which extends along a plane running perpendicular to the second extent direction 29, of a portion of the guide portion 5 on a side of the guide portion 5 that faces toward the fixing portion 9, such that particularly precise guidance of the brake pad arrangement relative to the brake anchor 19 in an axial direction 25 is ensured.

As has likewise already been described, the guide element 1 has the guide portion 5. The guide portion 5 has a first end portion and a second end portion and extends from the first end portion to the second end portion. The second end portion of the planar portion 15 and the first end portion of the guide portion 5 transition directly into one another. The guide portion 5 has a first portion comprising the first end portion, has a second portion, and has a third portion comprising the second end portion. The first portion extends perpendicular to the planar portion 15. The second portion extends perpendicular to the first portion, and the third portion extends perpendicular to the second portion.

The second portion of the guide portion 5 extends along the second extent direction 29 and is arranged between the first portion and the third portion along the second extent direction 29. The second portion has a first surface on the first side and has a second surface on the second side. The first surface and the second surface of the second portion extend in each case along a corresponding plane that is arranged perpendicular to the first extent direction 27, wherein the first surface and the second surface face away from one another.

In one exemplary arrangement, the second portion of the guide portion 5 and the arrangement of the first portion of the guide portion 5 and of the third portion of the guide portion 5 relative to the second portion define both the first side of the guide element 1 and the second side of the guide element 1. The first portion, the second portion and the third portion together form a U-shape, wherein the first side is arranged on the closed side of the U-shape and the second side is arranged on the open side of the U-shape. The first portion and the third portion extend away from the second portion, and along the first extent direction 27, on the second side. Both the first portion and the third portion extend in each case perpendicularly away from the second portion. The first portion has a first surface on the first side and has a second surface on the second side. The first surface and the second surface of the first portion extend in each case along a corresponding plane that is arranged perpendicular to the second extent direction 29, wherein the first surface and the second surface face away from one another.

The third portion has a first surface on the first side and has a second surface on the second side. The first surface and the second surface of the third portion extend in each case along a corresponding plane that is arranged perpendicular to the second extent direction 29, wherein the first surface and the second surface face away from one another.

The guide portion 5 engages, on the first side, into the guide groove 23, and the guide projection engages, on the second side, into the guide portion 5. The guide portion 5 is configured such that the guide element 1 is adapted both to the shape of the guide groove 23 and to the shape of the guide projection. The engagement of the guide portion 5 into the guide groove 23 and the engagement of the guide projection into the guide portion 5 is such that both the guide projection and the second surface of the first portion and the guide projection and the second surface of the second portion are in each case spaced apart from one another. The guide portion 5 ensures a reliable adjustment of the brake pad arrangement in an axial direction 25 relative to the brake anchor 19 in that forces acting along the second extent direction 29 can be transmitted from the guide projection to the third portion of the guide portion 5 and from the third portion of the guide portion 5 to the brake anchor 19. In one exemplary arrangement, the spring force arising from the elastically deformed spring portion 13 acts on the brake pad arrangement such that the latter bears with an abutment surface, which extends along a plane arranged perpendicular to the second extent direction 29, of the guide projection against the second surface of the third portion of the guide portion 5, such that precise guidance of the brake pad arrangement relative to the brake anchor 19 in an axial direction 25 is ensured. In one exemplary arrangement, here, the first surface of the third portion of the guide portion 5 bears against a surface of the brake anchor 19 which extends along a plane oriented perpendicular to the second extent direction 29 and which forms a portion of a surface of the guide groove 23.

As has likewise already been described, the guide element 1 has the connecting portion 11. The connecting portion 11 extends from a first end portion along the second extent direction 29 to a second end portion. The second end portion of the guide portion 5 and the first end portion of the connecting portion 11 transition directly into one another. The connecting portion 11 has in each case one corresponding surface on the first side of the guide element 1 and on the second side of the guide element 1. The two surfaces of the connecting portion 11 extend in each case along a corresponding plane that is arranged perpendicular to the first extent direction 27, wherein the two surfaces of the connecting portion 11 face away from one another. In the assembled state, a first surface of the two surfaces of the connecting portion 11 faces toward the brake anchor 19, and a second surface of the two surfaces of the connecting portion 11 faces toward the brake pad arrangement. For example, by virtue of the first surface, which faces toward the brake anchor 19, the connecting portion 11 may bear against a surface of the brake anchor 19, such that the guide element 1 is optimally positioned relative to the brake anchor 19 when a braking operation of the disk brake system is performed. Furthermore, the second surface, which faces toward the brake pad arrangement, allows the connecting portion 11 to bear against a surface of the brake pad arrangement, such that the guide element 1 is optimally positioned relative to the brake pad arrangement when a braking operation of the disk brake system is performed.

The connecting portion 11 has a first portion 31 comprising the first end portion, a second portion 33 comprising the second end portion, and a third portion 35. The third portion 35 may have a portion of the first portion 31 and/or a portion of the second portion 33. In one exemplary arrangement, the first portion 31 and the second portion 33 serve for describing the extent of the connecting portion 11 along the axial direction 25. The third portion 35 serves for describing the extent of the connecting portion 11 along the second extent direction 29.

The connecting portion 11 extends along the axial direction 25 from a first plane, which runs perpendicular to the axial direction 25, to a second plane, which runs perpendicular to the axial direction 25. This extent of the connecting portion 11 is ensured by the extent of the first portion 31 along the axial direction 25, because the first portion 31 extends along the axial direction 25 from the first plane to the second plane. The extent of the first portion 31 along the axial direction 25 corresponds to the maximum extent of the connecting portion 11 along the axial direction 25. The second portion 33 is spaced apart in an axial direction 25 both from the first plane and from the second plane. By virtue of the fact that the second portion 33 is spaced apart in an axial direction 25 both from the first plane and from the second plane, a connecting portion 11 is provided which is particularly space-saving, material-saving and weight-saving. The second portion 33 has two abutment elements 37 which extend parallel to one another and along the second extent direction 29. The two abutment elements 37 are arranged, and spaced apart from one another in an axial direction 25, such that the fixing portion 9 is arranged between the two abutment elements 37 along the axial direction 25. This design of the two abutment elements 37 ensures a large abutment area of the connecting portion 11 for abutment against the brake anchor 19, and a large abutment surface of the connecting portion 11 for abutment against the brake pad arrangement, in order to simultaneously provide a space-saving, material-saving and weight-saving arrangement of the fixing portion 9.

The third portion 35 of the connecting portion 11 extends along the second extent direction 29 from a third plane, which runs perpendicular to the second extent direction 29, to a fourth plane, which runs perpendicular to the second extent direction 29. The third plane and the fourth plane are arranged such that the fixing portion 9 is arranged entirely between the third plane and the fourth plane. The connecting portion 11 thus extends along the second extent direction 29 further than the fixing portion 9 does. Furthermore, a portion of the connecting portion 11 is arranged on one side of the fixing portion 9 along the second extent direction 29, and a further portion of the connecting portion 11 is arranged on the other side of the fixing portion 9 along the second extent direction 29. By virtue of the fact that the fixing portion 9 is arranged entirely between the third plane and the fourth plane, forces that are exerted on the connecting portion 11 by the fixing portion 9 can be transmitted to the brake anchor 19 or to the brake pad arrangement in an efficient manner. This applies to forces that act along the first extent direction 27, or to forces that have at least one component that acts along the first extent direction 27.

As has likewise already been described, the guide element 1 has the fixing portion 9. The fixing portion 9 extends from an end portion along the first extent direction 27 to a free end. The fixing portion 9 extends, at least in certain portions, perpendicularly with respect to the connecting portion 11. The second end portion of the connecting portion 11 and the end portion of the fixing portion 9 transition directly into one another. The fixing portion 9 has an elastically deformable spring portion. The spring portion 13 of the guide element 1 may also be referred to as first spring portion, and the spring portion of the fixing portion 9 may also be referred to as second spring portion. Similarly to the first spring portion, the second spring portion can also be brought from an unloaded state into an elastically prestressed state, in which the second spring portion is elastically deformed. In one exemplary arrangement, the second spring portion is not deformed in the unloaded state. In the elastically prestressed state, the second spring portion is deformed in linearly elastic fashion. A linearly elastic deformation of the second spring portion in the elastically prestressed state ensures that the second spring portion can be brought from the unloaded state into the elastically prestressed state and from the elastically prestressed state back into the unloaded state again, without residual plastic deformation of the second spring portion. In the unloaded state, the second spring portion can assume its original shape, without plastic deformation components influencing a future deformation behavior of the second spring portion. Furthermore, a linearly elastic deformation of the second spring portion in the elastically prestressed state can make it possible for a force that is exerted by the second spring portion in the elastically prestressed state to be maintained over a long period of use. The second spring portion is configured such that the second spring portion, in the elastically deformed state, bears with an abutment surface against an abutment portion of the brake anchor 19 such that a spring force acting along the second extent direction 29 is exerted on the guide element 1. For example, the spring force acts on the guide element 1 such that the guide element 1 is forced, along the second extent direction 29, with the first surface of the third portion of the guide portion 5 against a surface, which extends along a plane arranged perpendicular to the second extent direction 29, of the brake anchor 19, such that the guide element 1 can be fastened securely to a portion of the brake anchor 19. The fixing portion 9 has a curved shape such that the fixing portion 9 deviates, at least in certain portions along the second extent direction 29, from a planar extent along a plane running perpendicular to the second extent direction 29. This curved constitutes a structurally particularly simple exemplary arrangement with which elastic deformability of the second spring portion can be ensured. It is self-evidently also possible for other shapes to ensure elastic deformability of the second spring portion. The curved shape can likewise be utilized for ensuring a form-fitting connection between the guide element 1 and the brake anchor 19. This form-fitting connection may be provided as an alternative or in addition to a force fit, provided by way of an elastically deformed second spring portion, between the guide element 1 and the brake anchor 19.

A particular advantage in the case of the first exemplary arrangement and in the case of the second exemplary arrangement of the guide element 1 according to the disclosure is that the fixing portion 9 is spaced apart in an axial direction 25 both from the first plane and from the second plane, wherein the connecting portion 11 extends along the axial direction 25 from the first plane to the second plane. The extent of the fixing portion 9 along the axial direction 25 is thus smaller than the extent of the connecting portion 11 along the axial direction 25. For example, provision is made whereby the extent of the connecting portion 11 along the axial direction 25 corresponds to at least three times the extent of the fixing portion 9 along the axial direction 25, which has led to surprisingly secure fastening of the guide element 1 on the brake anchor 19.

In one exemplary arrangement, in relation to a guide element in the case of which the fixing portion extends in an axial direction 29 as far as or further than a corresponding connecting portion, the guide element 1 according to the disclosure provides a space-saving, material-saving and weight-saving alternative, because the fixing portion 9 is spaced apart in an axial direction 25 both from the first plane and from the second plane. In one exemplary arrangement, the fixing portion 9 may be provided as a single arm which extends as a single piece from its end portion to its free end, which provides a space-saving, material-saving and weight-saving alternative in particular in relation to guide elements in the case of which two individual arms are provided, which each extend as a single piece from a corresponding end portion to a corresponding free end. In one exemplary arrangement, the fixing portion 9 extends such that a main extent plane of the fixing portion 9 is provided perpendicular to the second extent direction 29, wherein the fixing portion 9 extends along said main extent plane. For example, an extent of the fixing portion 9 perpendicular to said main extent plane is smaller than an extent of the fixing portion 9 along said main extent plane, such that forces that act perpendicular to said main extent plane can be introduced into the fixing portion 9 in an effective manner. As already described, the fixing portion 9 can have a curved shape. Owing to the curved shape, the fixing portion 9 does not extend entirely along the main extent plane. Rather, the fixing portion 9 extends, at least in certain portions, in the main extent plane and entirely between two planes running parallel to the main extent plane, which planes enclose the main extent plane between them, and the spacing of which planes to one another is smaller than an extent of the fixing portion 9 along the axial direction 25 and is smaller than an extent of the fixing portion 9 along the first extent direction 27. In one exemplary arrangement, the fixing portion 9, at its free end, has no portion that extends along the second extent direction 29 from a surface, pointing in the direction of the guide portion 5, of the fixing portion 9, such that the guide element 1 lies with its fixing portion 9 against a portion of the brake anchor 19 and the mounting of the guide element 1 onto the brake anchor 19 can be performed easily and quickly.

In summary, it can thus be stated that a space-saving, material-saving and weight-saving guide element 1 is ensured by way of the arrangement and design of the fixing portion 9. For example, the fixing portion 9 may bear, by two edges which are situated opposite one another along the axial direction 25 and which extend along the first extent direction 27, against corresponding portions of the brake anchor 19 such that precise positioning of the guide element 1 relative to the brake anchor 19 is ensured, and securing of the guide element 1 against movement along the axial direction 25 relative to the brake anchor 19 is ensured.

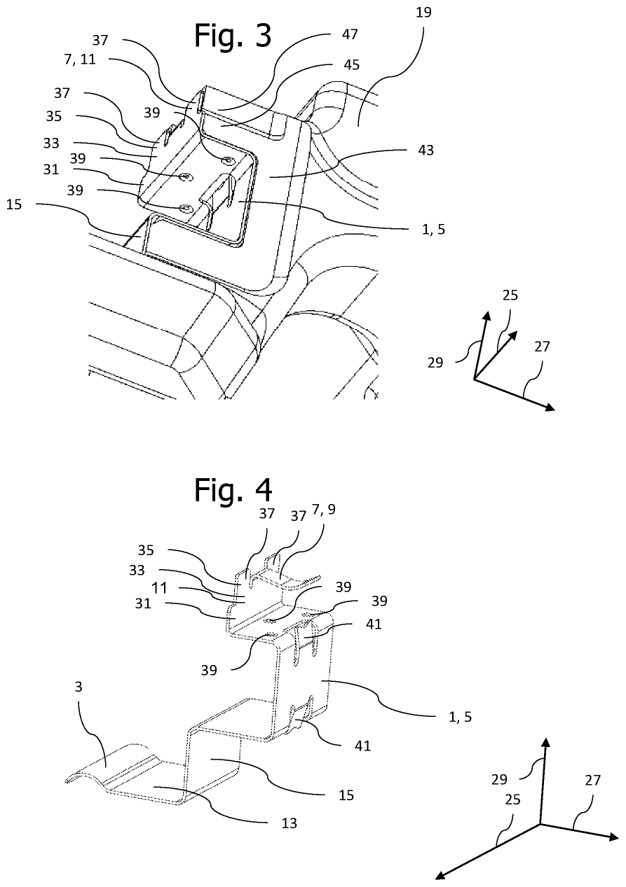

As illustrated in FIGS. 3 and 4, the third portion of the guide portion 5 has three projections 39 on the first side of the guide element 1. Each of the three projections 39 extends along the second extent direction 29 away from the first surface, which in FIG. 4 points upward, of the third portion of the guide portion 5. The first surface of the third portion of the guide portion 5 extends along a plane running perpendicular to the second extent direction 29. By virtue of the three projections 39 engaging by way of their free end with a surface of the brake anchor 19, and the first surface of the third portion of the guide portion 5 not engaging, or at least not only the first surface of the third portion of the guide portion 5 engaging, with the surface of the brake anchor 19, it was possible to considerably reduce the generation of noise during the use of the guide element 1, for example during a braking operation.

FIGS. 3 and 4 furthermore illustrate that the second portion of the guide portion 5 has two hooks 41 which extend in each case from an end portion to a free end and which extend in opposite directions along the second extent direction 29. In one exemplary arrangement, the free ends are arranged such that one free end extends beyond the first surface of the first portion of the guide portion 5 (illustrated at the bottom in FIG. 4) and the other free end extends beyond the first surface of the third portion of the guide portion 5 (illustrated at the top in FIG. 4), such that said free ends can each engage into a corresponding recess in an otherwise substantially planar surface of the guide groove 23 of the brake anchor 19. Each of the hooks 41 thus ensures secure fixing of the guide element 1 on the brake anchor 19.

As has already been described, the guide element 1 has the two fastening portions 17. The two fastening portions 17 are in each case of mirror-symmetrical design with respect to one another and are arranged on correspondingly symmetrically arranged portions of the connecting portion 11. A first fastening portion 17, which is concealed in FIG. 8, has a first surface extending along a plane that is arranged perpendicular to the axial direction 25. By virtue of the first surface, the first fastening portion 17 can bear against a corresponding portion of the brake anchor 19. A second fastening portion 17, which is illustrated in FIG. 8, has a second surface extending along a plane that is arranged perpendicular to the axial direction 25. The second surface allows the second fastening portion 17 to bear against a corresponding portion of the brake anchor 19. The first surface and the second surface face toward one another, such that a portion of the brake anchor 19 is encompassed in two opposite directions along the axial direction 25 by the two fastening portions 17 such that, in addition to the fixing function by the fixing portion 9, the guide element 1 is fixed along the axial direction 25 by the two fastening portions 17, whereby robust fixing of the guide element 1 on the brake anchor 19 along the axial direction 25 is ensured.

Aside from the guide element 1 according to the disclosure, the disclosure also relates to a brake anchor 19 according to the disclosure, of which a portion is illustrated in each of the figures, and which has already partially been described. The brake anchor 19 has the guide groove 23 that extends along the axial direction 25. In the assembled state, in which the guide element 1 is attached to the brake anchor 19, the axial direction 25, the first extent direction 27 and the second extent direction 29 are identical both for the guide element 1 and for the brake anchor 19. In a state in which the guide element 1 is not attached to the brake anchor 19, the axial direction 25, the first extent direction 27 and the second extent direction 29 may differ in each case for the guide element 1 and the brake anchor 19. The brake anchor 19 has a guide portion 43, which has the guide groove 23, a connecting portion 45, which adjoins the guide portion 43, and a holding portion 47, which adjoins the connecting portion 45. The connecting portion 45 extends along the axial direction 25 from a fifth plane, which runs perpendicular to the axial direction 25, to a sixth plane, which runs perpendicular to the axial direction 25. In the first exemplary arrangement and the second exemplary arrangement, the first plane corresponds to the fifth plane and the second plane corresponds to the sixth plane, such that an extent of the connecting portion 11 of the guide element 1 along the axial direction 25 corresponds to an extent of the connecting portion 45 of the brake anchor 19 along the axial direction 25.

The holding portion 47 has a holding groove 49 into which the fixing portion 9 can engage. In the assembled arrangement, the fixing portion 9 of the guide element 1 is arranged entirely in the holding groove 49 of the brake anchor 19. The holding groove 49 extends along the first extent direction 27 from a first end to a second end. The holding groove 49, at its second end, is open along the first extent direction 27, whereby the guide element 1 can be attached particularly easily by way of its fixing portion 9 to the brake anchor 19. In an axial direction 25, the holding groove 49 is spaced apart both from the fifth plane and from the sixth plane, such that the holding portion 47 may have two limbs which extend along the first extent direction 27 and which delimit the holding groove 49 and prevent a movement of the fixing portion 9 along the axial direction 25. For example, only one holding groove 49 is provided. The connecting portion 45 has an abutment surface which points in the first extent direction 27 and which extends along a seventh plane running perpendicular to the first extent direction 27 and against which the connecting portion 11 of the guide element 1 can bear. Said abutment surface and the second end of the holding groove 49 transition directly into one another, such that the guide element 1 can be attached easily to the brake anchor 19. An extent of the holding groove 49 in a direction from the fifth plane to the sixth plane tapers toward a surface of the holding portion 47, which surface extends along a plane which is arranged perpendicular to the second extent direction 29 and which delimits the holding groove 49 in the direction of the second extent direction 29. In other words, the extent of the holding groove 49 in a direction from the fifth plane to the sixth plane increases along the second extent direction 29. The thus increasing extent of the holding groove 49 ensures optimum positioning of the guide element 1 on the brake anchor 19. An extent of the holding groove 49 in a direction from the fifth plane to the sixth plane may be defined by an extent of the holding groove 49 along a straight line that is defined by an intersection of two planes, of which one extends perpendicular to the first extent direction 27 and one extends perpendicular to the second extent direction 29. A surface, pointing in the second extent direction 29, of the holding groove 49 has a roughness that corresponds to or is greater than a minimum roughness, wherein the minimum roughness corresponds to an average roughness value of 0.8 micrometers. For example, an average roughness value of 0.8 micrometers may be achieved by virtue of at least the holding portion 47 of the brake anchor 19 being produced by casting. It has surprisingly been found that, if the minimum roughness corresponds to an average roughness value of 0.8 micrometers, the guide element 1 can be attached reliably to the brake anchor 19 and, a movement of the guide element 1 along the first extent direction 27 during a braking operation can be avoided.

Aside from the guide element 1 according to the disclosure and the brake anchor 19 according to the disclosure, the present disclosure also relates to a brake system according to the disclosure, which has already partially been described. In the case of the brake system according to the disclosure, the fixing portion 9 and the holding groove 49 each extend, at least in certain portions, along the axial direction 25 such that the fixing portion 9 bears, at least in certain portions, against two mutually oppositely situated abutment surfaces that define the extent of the holding groove 49 in the axial direction 25. This design allows for stable securing of the guide element 1 relative to the brake anchor 19 along the axial direction 25. For example, the fixing portion 9 may bear with two mutually oppositely situated edges, which extend along the first extent direction 27, against the surfaces of the holding groove 49, wherein in each case one edge bears against one surface, and in this way the guide element 1 is secured against movement along the axial direction 25 relative to the brake anchor 19.

It is additionally pointed out that “having” does not rule out any other elements or steps, and “a” or “an” does not rule out a multiplicity. It is also pointed out that features that have been described with reference to any one of the above exemplary arrangements may also be used in combination with other features of other above-described exemplary arrangements. Reference designations in the claims are not to be regarded as limiting.

1. A guide element for a disk brake system comprising a brake anchor with a guide groove which extends along an axial direction, and a brake pad arrangement which is adjustable relative to the brake anchor along the axial direction and which has a guide projection protruding into the guide groove;
wherein the guide element extends from a first end via a guide portion to a second end, and said guide element has a fixing portion, said fixing portion being arranged at the second end and extending along a first extent direction, which runs transversely with respect to the axial direction, to a free end, and said guide element has a connecting portion between the guide portion and the fixing portion, said connecting portion extending along a second extent direction, which runs transversely with respect to the axial direction and transversely with respect to the first extent direction, and extending along the axial direction from a first plane, which runs perpendicular to the axial direction, to a second plane, which runs perpendicular to the axial direction, and
wherein the fixing portion is spaced apart in an axial direction both from the first plane and from the second plane.

2. The guide element as claimed in claim 1, wherein the fixing portion and the connecting portion transition directly into one another.

3. The guide element as claimed in claim 1, wherein the fixing portion has an elastically deformable spring portion.

4. The guide element as claimed in claim 1, wherein the fixing portion has a curved shape such that the fixing portion deviates, at least in certain portions along the second extent direction, from a planar extent along a plane running perpendicular to the second extent direction.

5. The guide element as claimed in claim 1, wherein the guide portion has at least one projection which extends, along the second extent direction, away from a surface of the guide portion, which surface extends along a plane running perpendicular to the second extent direction.

6. The guide element as claimed in claim 1, wherein the connecting portion has a first portion, which extends along the axial direction from the first plane to the second plane, and a second portion, which is spaced apart in the axial direction both from the first plane and from the second plane.

7. The guide element as claimed in claim 1, wherein the connecting portion has a third portion which extends along the second extent direction from a third plane, which runs perpendicular to the second extent direction, to a fourth plane, which runs perpendicular to the second extent direction, wherein the third plane and the fourth plane are arranged such that the fixing portion is, at least in certain portions, arranged between the third plane and the fourth plane.

8. A brake anchor for a disk brake system, comprising a guide groove which extends along an axial direction and a brake pad arrangement which is adjustable relative to the brake anchor along the axial direction and which has a guide projection protruding into the guide groove,
wherein the brake anchor has a guide portion which has the guide groove, said brake anchor has a connecting portion which adjoins the guide portion and which extends along the axial direction from a fifth plane, which runs perpendicular to the axial direction, to a sixth plane, which runs perpendicular to the axial direction, and said brake anchor has a holding portion which adjoins the connecting portion, and
wherein the holding portion has a holding groove which extends along a first extent direction from a first end to a second end and which, at its second end, is open along the first extent direction and which is spaced apart in the axial direction both from the fifth plane and from the sixth plane.

9. The brake anchor as claimed in claim 8, wherein the connecting portion has an abutment surface which points in the first extent direction and which extends along a seventh plane running perpendicular to the first extent direction, wherein the abutment surface and the second end of the holding groove transition directly into one another.

10. The brake anchor as claimed in claim 8, wherein an extent of the holding groove in a direction from the fifth plane to the sixth plane increases along the second extent direction.

11. The brake anchor as claimed in claim 8, wherein a surface, pointing in the second extent direction, of the holding groove has a roughness that corresponds to or is greater than a minimum roughness, wherein the minimum roughness corresponds to an average roughness value of 0.8 micrometers.

12. A disk brake system
having a guide element as claimed in claim 1,
having a brake anchor, and
having a brake pad arrangement which is adjustable relative to the brake anchor along the axial direction and which has a guide projection protruding into the guide groove,
wherein the fixing portion of the guide element is, at least in certain portions, arranged in a holding groove of the brake anchor.

13. The disk brake system as claimed in claim 12, wherein the fixing portion and the holding groove each extend, at least in certain portions, along the axial direction such that the fixing portion bears, at least in certain portions, against two mutually oppositely situated abutment surfaces that define the extent of the holding groove in the axial direction.

14. The guide element as claimed in claim 3, wherein the fixing portion has a curved shape such that the fixing portion deviates, at least in certain portions along the second extent direction, from a planar extent along a plane running perpendicular to the second extent direction.

15. The guide element as claimed in claim 3, wherein the guide portion has at least one projection which extends, along the second extent direction, away from a surface of the guide portion, which surface extends along a plane running perpendicular to the second extent direction.

16. The guide element as claimed in claim 5, wherein the connecting portion has a first portion, which extends along the axial direction from the first plane to the second plane, and a second portion, which is spaced apart in the axial direction both from the first plane and from the second plane.

17. The guide element as claimed in claim 5, wherein the connecting portion has a third portion which extends along the second extent direction from a third plane, which runs perpendicular to the second extent direction, to a fourth plane, which runs perpendicular to the second extent direction, wherein the third plane and the fourth plane are arranged such that the fixing portion is, at least in certain portions, arranged between the third plane and the fourth plane.

18. The brake anchor as claimed in claim 9, wherein an extent of the holding groove in a direction from the fifth plane to the sixth plane increases along the second extent direction.
